(19) United States
(12) Patent Application Publication
(10) Pub. No.: US 2017/0277548 A1
(43) Pub. Date: Sep. 28, 2017

(54) REMOTE OPERATING SYSTEM AND INFORMATION PROCESSING METHOD

(71) Applicant: MITSUBISHI ELECTRIC CORPORATION, Tokyo (JP)

(72) Inventors: Toshiyuki HAGIWARA, Tokyo (JP); Noboru HAMAGUCHI, Tokyo (JP); Hideki NARITA, Tokyo (JP)

(73) Assignee: MITSUBISHI ELECTRIC CORPORATION, Tokyo (JP)

(21) Appl. No.: 15/510,731

(22) PCT Filed: Nov. 12, 2015
(86) PCT No.: PCT/JP2015/081844

§ 371 Date: Mar. 13, 2017

(30) Foreign Application Priority Data
Dec. 17, 2014 (JP) 2014-254871

(51) Int. Cl. G06F 9/44; G06F 9/455

(52) U.S. Cl. CPC G06F 9/4445; G06F 9/45558; G06F 2009/45595; H04L 67/10

(57) ABSTRACT

An object of the present invention to provide a remote operating system and an information processing method which reduce a burden on a user's operation and suppress a user's erroneous operation. A remote operating system according to the present invention is a remote operating system which includes an operation target device and a remote operating device connected via a network, and in which a first controller causes a display signal interface to output a display signal for displaying a remote operating window corresponding to a selected window, and, when a cursor position is out of a movable area of a cursor, the second controller changes a position of the selected window and the cursor position such that the cursor position comes in the movable area of the cursor while maintaining a relative positional relationship between the position of the selected window and the cursor position.

### TECHNICAL FIELD

The present invention relates to a remote operating system and an information processing method and, more particularly, relates to a remote operating device and an information processing method which remotely operate an operation target device via a network.

### BACKGROUND ART

Remote operating systems which each operate a computer connected to the same network by using a keyboard or a mouse of another computer are known. The remote operating systems are used in fields of electronic conferences in which a plurality of persons shares a screen and exchanges information, and remote maintenance for maintaining computers at remote places.

Each remote operating system is composed of an operation target device which is a remote operating target, and a remote operating device which is connected with the operation target device via a network, and operates the operation target device. There is a plurality of remote operating devices in some cases. The remote operating device displays on a screen a remote operating window corresponding to a screen of the operation target device. A user operates the key or the mouse for the remote operating window. The remote operating device obtains operation information of the keyboard or the mouse, and transmits this operation information to the operation target device. The operation target device executes processing based on the operation information transmitted from the remote operating device.

Consequently, the user of the remote operating device can operate the operation target device as if the user operated the operation target device by using a mouse or a keyboard of the operation target device.

### PRIOR ART DOCUMENTS

### Patent Documents

Patent Document 1: Japanese Patent Application Laid-Open No. 2010-256965

### SUMMARY OF INVENTION

### Problems to be Solved by the Invention

However, according to the conventional remote operating systems, when part of an operation target window goes out of the screen of the operation target device or hides behind another window, it is necessary to move this part of the window to the inside of the screen or move the window to a frontmost side by operating the mouse.

Further, the entire screen of the operation target device is an operation target, and therefore another window can also be operated. Hence, there is also a problem that, when only a specific window needs to be operated, another window is operated by mistake.

The present invention has been made in light of the above problem, and an object of the present invention is to provide a remote operating system and an information processing method which reduce a burden on a user's operation and suppress a user's erroneous operation.

### Means for Solving the Problems

A remote operating system according to the present invention is a remote operating system which includes an operation target device and a remote operating device connected via a network, and in which the remote operating device includes a first communicator which communicates with the operation target device via the network, an operation recognizer which recognizes an operation with respect to the remote operating device, a display signal interface which outputs a display signal, and a first controller, the operation target device includes a second communicator which communicates with the remote operating device via the network, and a second controller, the first controller obtains a display window information list related to information of a window opened on the operation target device via the first communicator, the first controller causes the display signal interface to output the display signal for displaying a window list based on the display window information list, the first controller notifies the operation target device of which window has been selected via the first communicator when the operation recognizer recognizes an operation of selecting one of windows in the window list, the first controller causes the display signal interface to output the display signal for displaying a remote operating window corresponding to the selected window, the first controller transmits operation information including an operation with respect to the remote operating window recognized by the operation recognizer, to the operation target device via the first communicator, the second communicator receives which window has been selected from the window list, from the remote operating device, the second communicator receives the operation information from the remote operating device, the second controller calculates a cursor position on the operation target device based on the operation information, and, when the calculated cursor position is out of a movable area of the cursor, the second controller changes a position of the selected window and the cursor position such that the cursor position comes in the movable area of the cursor while maintaining a relative positional relationship between the position of the selected window and the calculated cursor position, and then executes processing with respect to the selected window based on the operation information.

### Effects of the Invention

The remote operating device displays the selected window on the remote operating window, so that a user can operate the selected window. Consequently, it is possible to prevent the user from operating another window.

Further, when a portion of an operation target window which needs to be operated is out of the screen of the operation target device, a position of the window which needs to be operated is moved to the inside of the screen in which the window can be operated by the cursor, and a cursor position is also simultaneously moved while maintaining a positional relationship with the window. Consequently, the user who operates the remote operating device does not need to perform an operation of changing the position of the operation target window, so that it is possible to prevent the user from performing an erroneous operation. Further, even when a window of a larger size than the screen is operated, it is possible to easily perform the operation.

Objects, features, aspects and advantages of the present invention will be more apparent from the following detailed description and the accompanying drawings.

### BRIEF DESCRIPTION OF DRAWINGS

FIG. 1 shows a functional block diagram of a remote operating system according to an embodiment of the present invention.

FIG. 2 shows a hardware configuration diagram of a remote operating system according to the embodiment of the present invention.

FIG. 3 shows a view showing an example of a window opened on an operation target device according to the embodiment of the present invention.

FIG. 4 shows a view showing a display window information list obtained by a remote operating device according to the embodiment of the present invention.

FIG. 5 shows a view showing a window list displayed by a remote operating device according to the embodiment of the present invention.

FIG. 6 shows a view showing a remote operating window displayed by the remote operating device according to the embodiment of the present invention.

FIG. 7 shows a view showing an example of operation information of the remote operating system according to the embodiment of the present invention.

FIG. 8 shows a view showing definitions of operation types of the remote operating system according to the embodiment of the present invention.

FIG. 9 shows a view showing items of data 1 and 2 per operation type of the remote operating system according to the embodiment of the present invention.

FIG. 10 shows a flowchart showing an operation of the remote operating system according to the embodiment of the present invention.

FIG. 11 shows a flowchart showing an operation of the remote operating system according to the embodiment of the present invention.

FIG. 12 shows a view showing screens of the remote operating device and the operation target device according to the embodiment of the present invention.

FIG. 13 shows a view showing the screens of the remote operating device and the operation target device according to the embodiment of the present invention.

### DESCRIPTION OF EMBODIMENT

<Configuration>

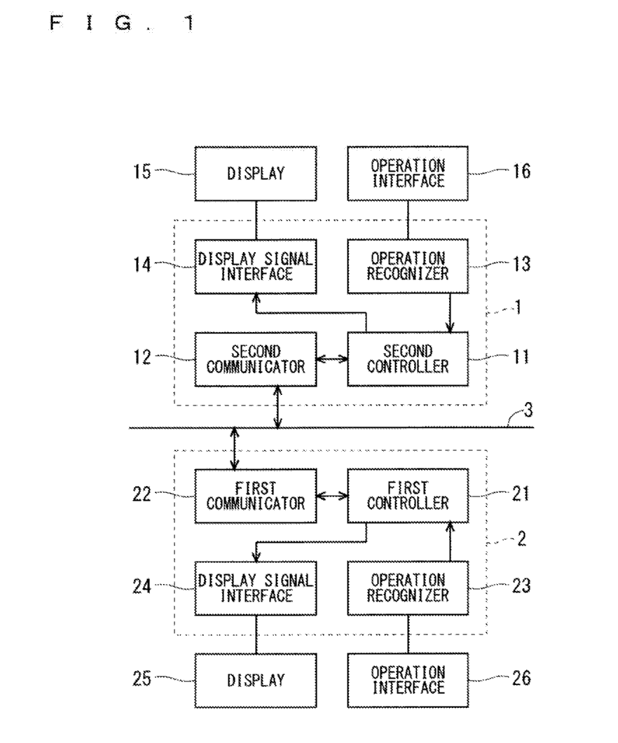

FIG. 1 shows a functional block diagram of a remote operating system according to an embodiment of the present invention. The remote operating system includes an operation target device 1 and a remote operating device 2. The operation target device 1 and the remote operating device 2 are connected via a network 3.

As shown in FIG. 1, the operation target device 1 includes a second controller 11, a second communicator 12, an operation recognizer 13 and a display signal interface 14. The second communicator 12 communicates with the remote operating device 2 via the network. The operation recognizer 13 is connected with an operation interface 16 to recognize an operation performed by the operation interface 16. The display signal interface 14 is connected with a display 15 to output a display signal to the display 15. The second controller 11 controls the second communicator 12 and the display signal interface 14 according to the operation recognized by the operation recognizer 13.

As shown in FIG. 1, the remote operating device 2 includes a first controller 21, a first communicator 22, an operation recognizer 23 and a display signal interface 24. The first communicator 22 communicates with the operation target device 1 via the network. The operation recognizer 23 is connected with an operation interface 26 to recognize an operation performed by the operation interface 26. The display signal interface 24 is connected with a display 25 to output a display signal to the display 25.

The first controller 21 controls the first communicator 22 and the display signal interface 24 according to the operation of the operation recognizer 23.

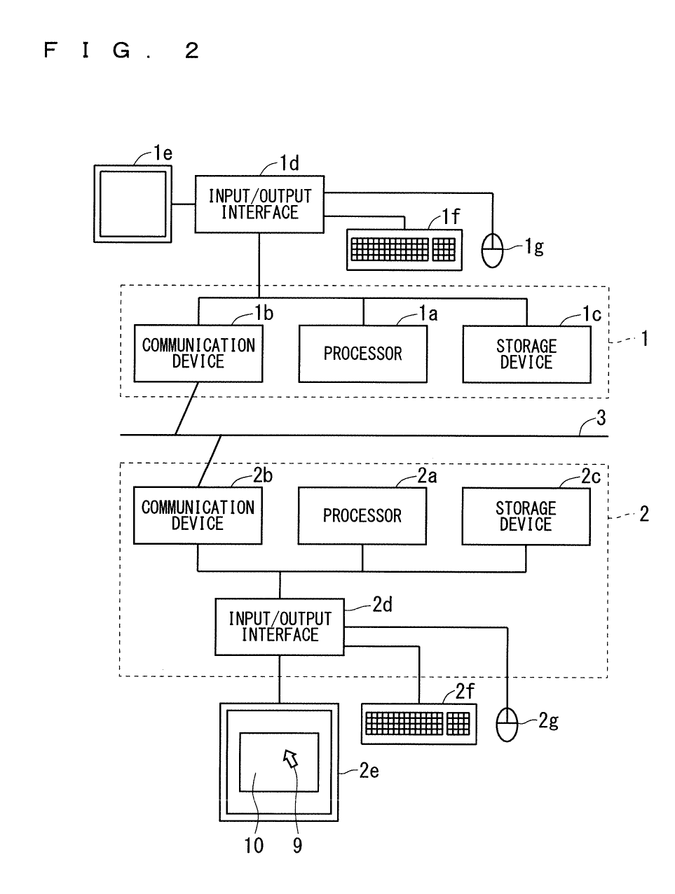

FIG. 2 shows a hardware configuration diagram of a remote operating system according to the embodiment of the present invention. The operation target device 1 is a computer, and a general-purpose operating system (the operating system will be referred to as an OS below) which a window system which can display a plurality of windows as graphical user interfaces is provided is mounted on the computer. This general-purpose OS is, for example, Microsoft Windows (registered trademark) operating system, yet may be other OSs.

The operation target device 1 includes a communication device 1b, a processor 1a, and a storage device 1c. In this regard, the operation target device 1 may be configured to include an input/output interface 1d. The input/output interface 1d is connected with, for example, a display le which is the display 15, and a keyboard 1f and a mouse 1g which are the operation interface 16. The processor 1a performs processing based on a program stored in the storage device 1c to realize the second controller 11. The communication device 1b operates based on a command of the processor 1a to realize the second communicator 12. The input/output interface 1d outputs a display signal for displaying an image on, for example, the display 1e based on the command of the processor 1a to realize the display signal interface 14. The processor 1a recognizes, for example, an operation of the keyboard 1f or the mouse 1g via the input/output interface 1d to realize the operation recognizer 13.

A screen 6 of a display signal outputted to the display 1e connected to the operation target device 1 has a resolution of 1920 pixels in a horizontal direction and 1080 pixels in a vertical direction, for example. The display le displays four windows 7A, 7B, 7C and 7D, for example. The cursor 8 is a cursor of the operation target device 1. The cursor 8 is movable in a range of the screen 6.

The remote operating device 2 is a computer, and a general-purpose OS which a window system which can display a plurality of windows as graphical user interfaces is provided is mounted on the computer.

The remote operating device 2 includes a communication device 2b, a processor 2a, a storage device 2c and an input/output interface 2d. The input/output interface 2d is connected with, for example, a display 2e which is the display 25, and a keyboard 2f and a mouse 2g which are the operation interface 26. The processor 2a performs processing based on a program stored in the storage device 2c to realize the first controller 21. The communication device 2b operates based on a command of the processor 2a to realize the first communicator 22. The input/output interface 2d outputs a display signal for displaying an image on, for example, the display 2e based on the command of the processor 2a to realize the display signal interface 24. The processor 2a recognizes, for example, an operation of the keyboard 1f or the mouse 1g via the input/output interface 2d to realize the operation recognizer 23.

A remote operating window 10 is displayed on a screen 27 of the display 2e connected to the remote operating device 2. The cursor 9 is a cursor of the remote operating device 2.

The network 3 is provided between the operation target device 1 and the remote operating device 2 to enable mutual communication between the operation target device 1 and the remote operating device 2. Although a general-purpose communication standard such as Ethernet (registered trademark) is used for mutual communication according to the present embodiment, other networks may be used.

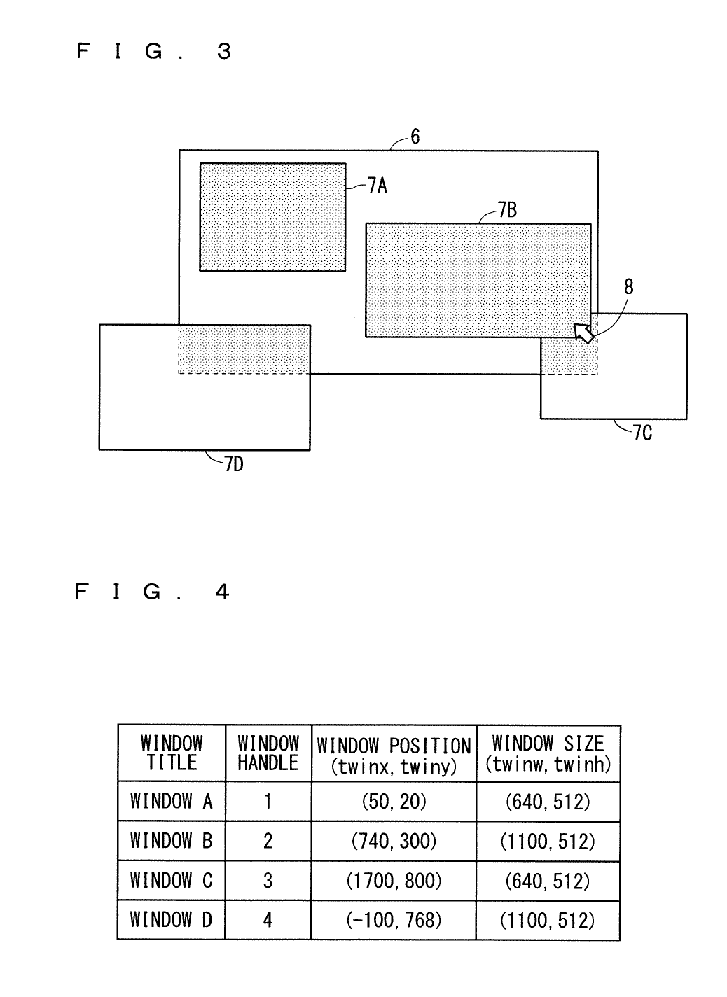

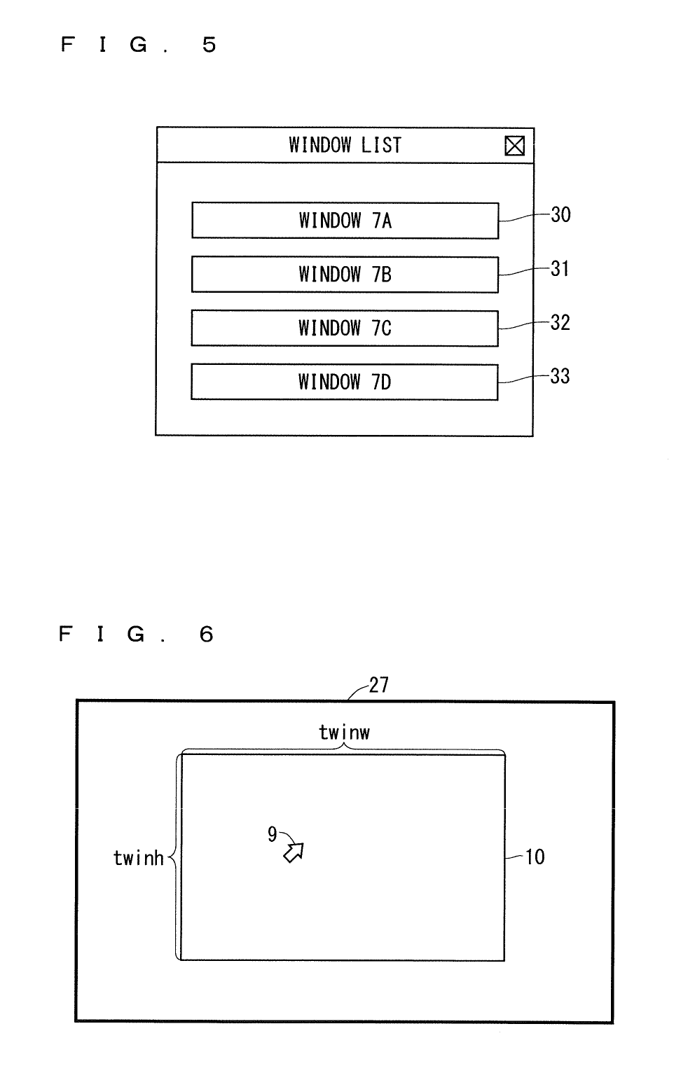

FIG. 4 shows a view showing a display window information list. The display window information list is an information list related to all windows displayed on the operation target device 1 (i.e., opened on the operation target device 1). The display window information list is configured by pieces of window information the number of which corresponds to the number of windows displayed on the operation target device 1. In FIG. 4, each row except a head is window information. The window information is configured by a window title which is a window name, a window handle which is a window specific identifier, a window position which is a coordinate at an upper left end of the window, and a window size which indicates a width and a height of the window. As shown in FIG. 3, the four windows 7A, 7B, 7C and 7D are displayed on the screen 6 of the operation target device 1, and therefore the display window information list is configured by four pieces of window information.

The first controller 21 of the remote operating device 2 causes the display signal interface 24 to output a display signal for displaying the window list, based on the display window information list obtained via the first communicator 22. FIG. 5 shows a view showing an example of a window list displayed on the screen 27 of the display 2e. A user operates, for example, the mouse 2g to select an operation target window which is a window of an operation target from the window list.

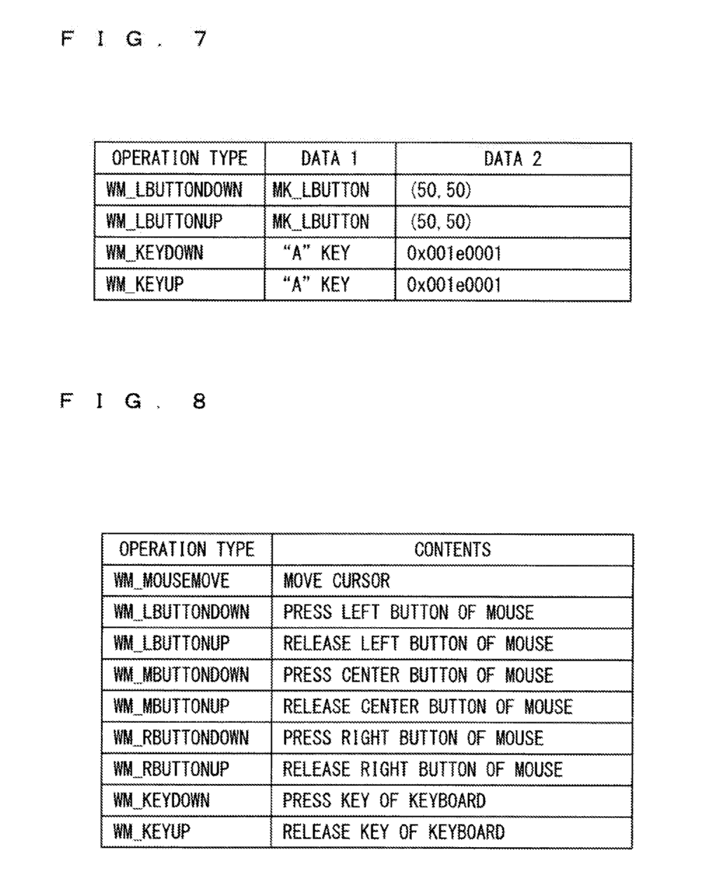

The first controller 21 of the remote operating device 2 displays on the screen 27 the remote operating window 10 which is a window for displaying the operation target window selected from the window list. FIG. 6 shows a view showing the remote operating window 10. In FIG. 6, the remote operating window 10 is generated as a window which includes a client area having pixels of the same width and height as those of the operation target window. The client area is an area except for a title bar and a boarder of a window. FIG. 6 shows a window without a title bar and a boarder. The first controller 21 obtains operation information of the keyboard 2f or the mouse 2g when there is the cursor 9 in the client area of the remote operating window 10. The user can operate all positions in the operation target window.

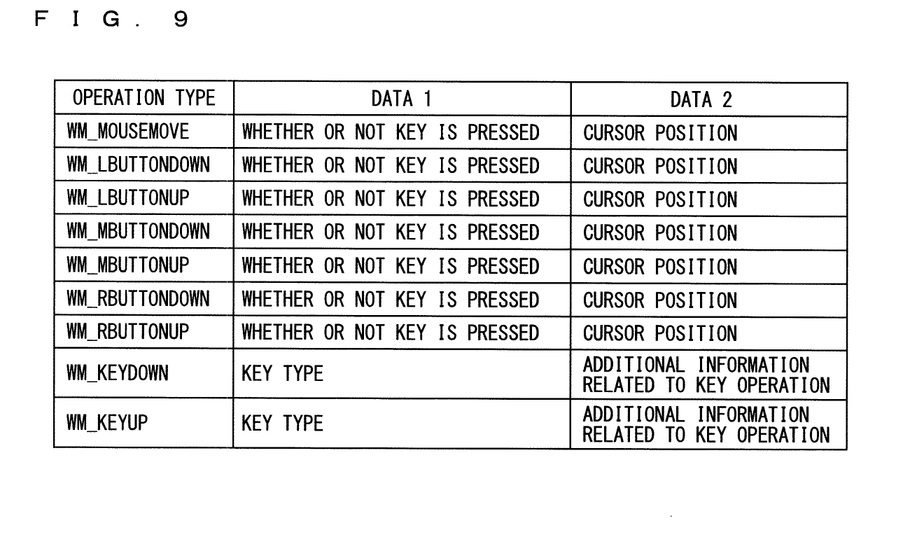

FIG. 7 shows an example of operation information. As shown in FIG. 7, the operation information includes three pieces of information of “operation type”, “data 1” and data 2”. The operation type indicates a type of an operation of the keyboard or the mouse.

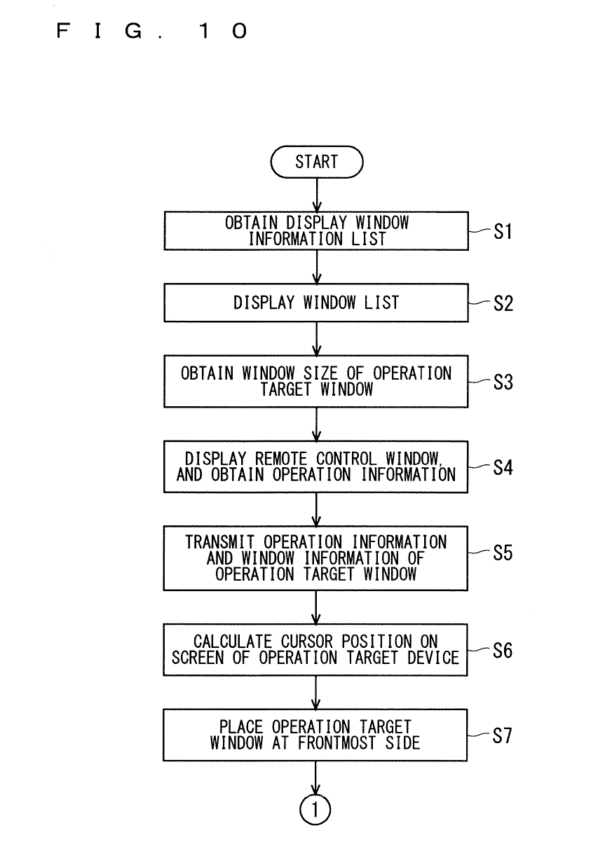

FIG. 8 shows a view showing definitions of operation types used in an operation type field in FIG. 7. The field of “operation type” indicates an operation type name, and a field of “contents” indicates operation contents. FIG. 8 shows part of operation types, and there may be operation types which are not shown in FIG. 8. The data 1 and the data 2 are items of data corresponding to operation types. FIG. 9 shows a view showing an example of the data 1 and the data 2 corresponding to the operation types. In FIG. 9, a cursor position indicates a client coordinate of the remote operating window of the cursor. The client coordinate of the remote operating window is a relative cursor coordinate in case where a position at an upper left end of the client area of the remote operating window is an origin (0, 0). First operation information (WM_LBUTTONDOWN) in FIG. 7 indicates that a left button of the mouse has been pressed at a cursor position (50, 50). Further, second operation information (WM_LBUTTONUP) indicates that the left button of the mouse has been released at the cursor position (50, 50). Third operation information (WM_KEYDOWN) indicates that a key “A” has been pressed. Fourth operation information (WM_KEYUP) indicates that the key “A” has been released.

The first controller 21 of the remote operating device 2 performs control to cause the first communicator 22 to transmit operation information and operation target window information which is display window information of the operation target window to the operation target device 1.

The second controller 11 of the operation target device 1 receives the operation information and the operation target window information from the remote operating device 2 via the second communicator 12. The second controller 11 calculates a cursor position of the cursor 8 on the screen 6 of the operation target device 1. When the cursor position included in the operation information is (lpx, lpy), the position at the upper left end of the operation target window on the screen 6 of the operation target device 1 is (twinx, twiny) and a size of the operation target window is (twinw, twinh), the cursor position (rpx, rpy) of the cursor 8 on the screen 6 of the operation target device 1 is calculated according to a following calculation equation.

rpx=twinx+lpx (Equation 1)

rpy=twiny+lpy (Equation 2)

The second controller 11 of the operation target device 1 places the operation target window at the frontmost side. Further, the second controller 11 determines whether or not the cursor position (rpx, rpy) of the cursor 8 on the screen 6 of the operation target device 1 is out of the screen 6 when the operation information is information of a mouse operation. More specifically, when the cursor position of the cursor 8 on the screen 6 of the operation target device 1 is (rpx, rpy) and a screen size of the screen 6 is (dispw, disph), determination is made according to whether or not following equation 3 and equation 4 are satisfied.

0≦rpx<dispw (Equation 3)

0≦rpx<dispw (Equation 4)

When both of above equation 3 and equation 4 are satisfied, it is determined that the cursor 8 is in the screen. In other cases, it is determined that the cursor 8 is out of the screen. When it is determined that the cursor 8 is out of the screen, the operation target window is moved such that an upper left end of the operation target window is positioned at a position (ntwinx, ntwiny) calculated according to the following calculation equations.

ntwinx=twinx−(rpx−centerx) (Equation 5)

ntwiny=twiny−(rpy−centery) (Equation 6)

(centerx, centery) in above equation 5 and equation 6 means a coordinate at a center of the screen 6 of the operation target device 1.

The second controller 11 moves the operation target window, and then moves the cursor 8 of the screen 6 of the operation target device 1 to the cursor position (centerx, centery). Although the operation target window is moved and then the cursor 8 is moved in the present embodiment, the cursor 8 may be moved before the operation target window is moved.

The second controller 11 of the operation target device 1 generates operation information whose cursor position is changed to a new cursor position (centerx, centery), and executes processing with respect to the operation target window based on the operation information.

<Operation>

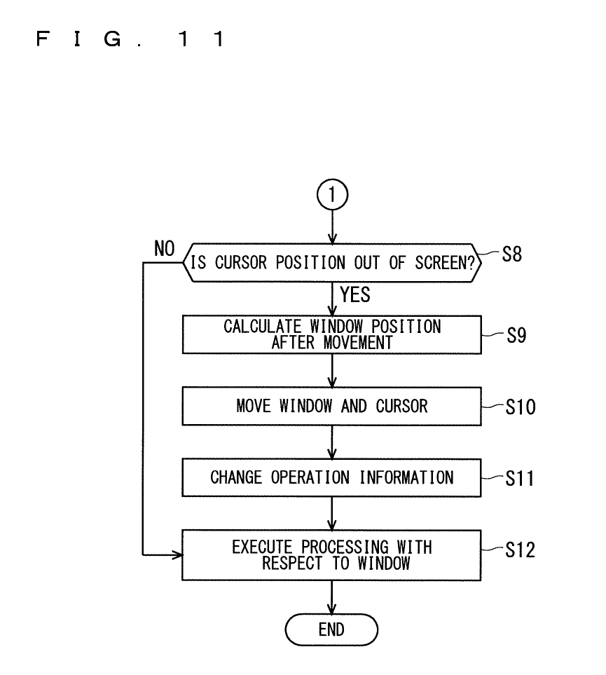

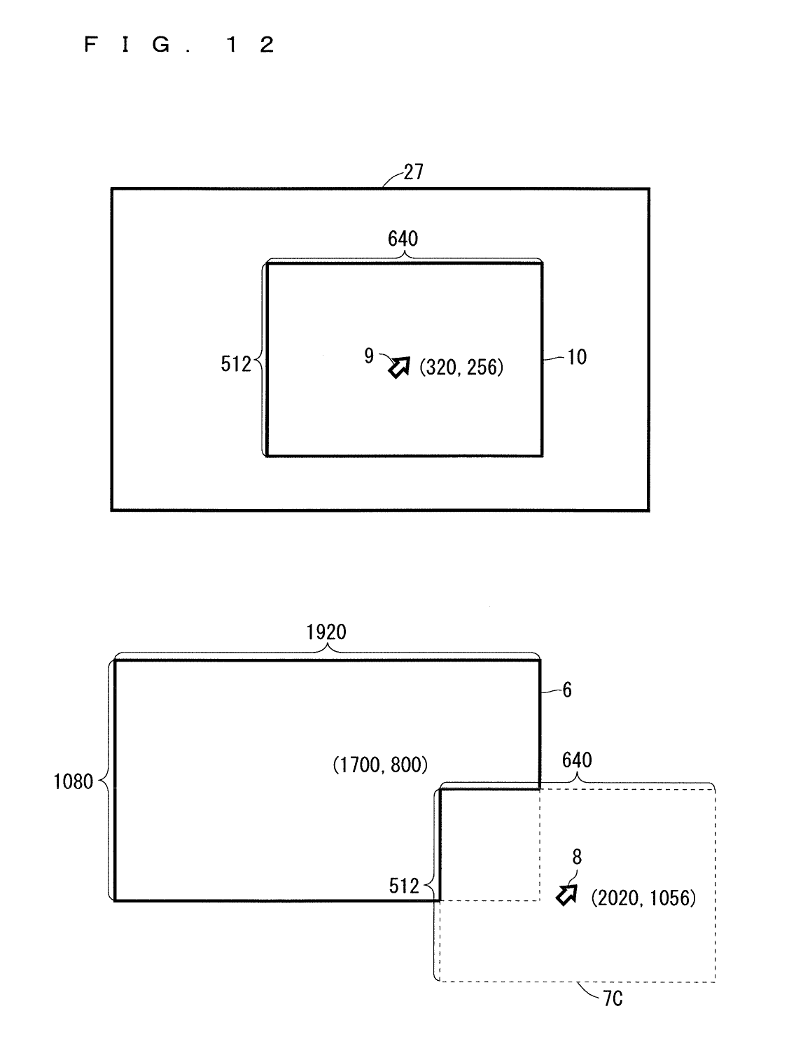

FIGS. 10 and 11 show flowcharts showing an operation of the remote operating system according to the embodiment of the present invention. A case where the user selects the window 7C of the operation target device 1 as the operation target window will be described below.

The first controller 21 of the remote operating device 2 obtains the display window information list (FIG. 4) which is information related to all windows displayed on the screen 6 of the operation target device 1 via the first communicator 22 (step S1). The four windows 7A, 7B, 7C and 7D are opened on the operation target device 1. That is, the four windows 7A, 7B, 7C and 7D are displayed on the screen 6 connected to the operation target device 1 (FIG. 3).

Next, the first controller 21 of the remote operating device 2 causes the display signal interface 24 to output the display window list based on the display window information list. As shown in FIG. 5, the window list is displayed on the screen 27 of the display 2e (step S2). In FIG. 5, a button 30 for selecting the window 7A, a button 31 for selecting the window 7B, a button 32 for selecting the window 7C and a button 33 for selecting the window 7D are placed. A window title of each window is displayed on each of the buttons 30 to 33 to indicate an association with each window displayed on the screen 6 of the operation target device 1. The user operates, for example, the mouse 2g and presses the button 32 to select the window 7C as the operation target window.

Next, the first controller 21 of the remote operating device 2 obtains a window size of the window 7C selected from the display window information list (step S3). The window size of the window 7C is (640, 512). The first controller 21 performs control to cause the display signal interface 24 to display the remote operating window 10 whose client area size is (640, 512) on the screen 27 of the display 2e. Further, the first controller 21 obtains operation information of the keyboard 2f or the mouse 2g operated by the user (step S4).

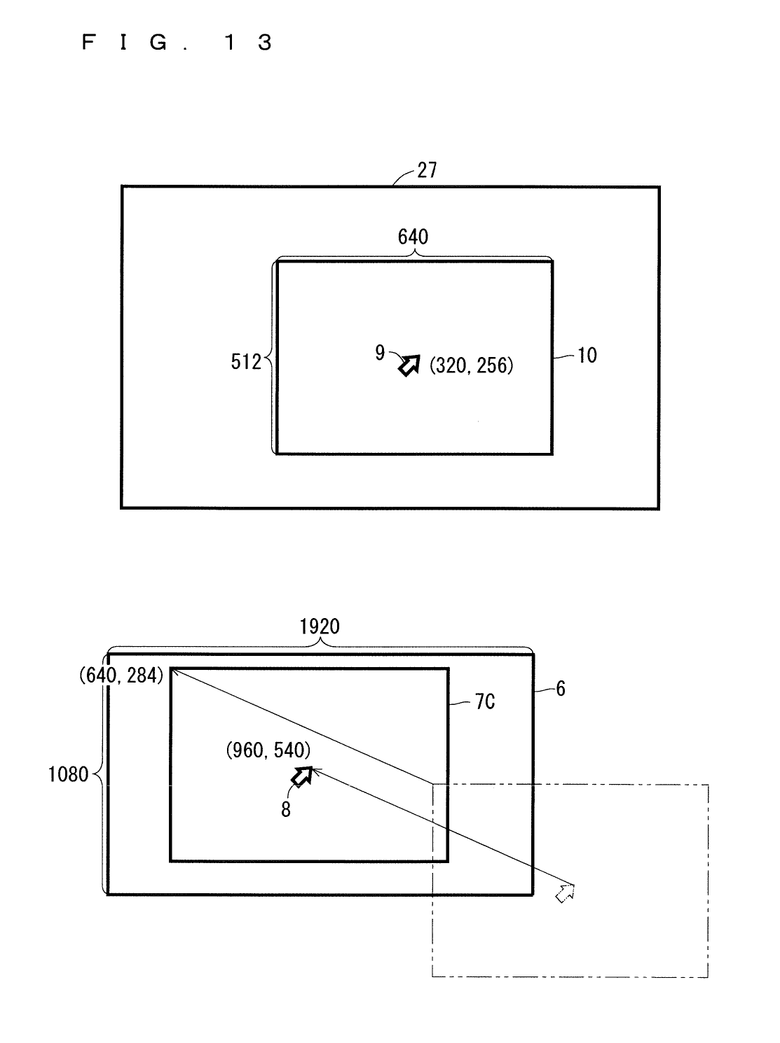

FIG. 12 shows a view showing a cursor position on the remote operating device and a cursor position on the operation target device. As shown in FIG. 12, when an operation of pressing the left button of the mouse 2g is performed at a position (320, 256) on the client area of the remote operating window 10, operation information whose operation type is WM LBUTTONDOWN, whose data 1 is MK_LBUTTON and whose data 2 is a cursor position (320, 256) is generated. The first controller 21 of the remote operating device 2 transmits this operation information and window information of the window 7C which is operation target window to the operation target device 1 via the first communicator 22 (step S5).

The second controller 11 of the operation target device 1 receives the operation information and the window information of the window 7C via the second communicator 12. The second controller 11 calculates the cursor position (rpx, rpy) of the cursor 8 on the screen 6 of the operation target device 1 based on the operation information included in the received operation information and related to the mouse by using equation 1 and equation 2 (step S6).

(twinx, twiny)=(1700, 800) holds in view of the window information of the window 7C and (lpx, lpy)=(320, 256) holds in view of the operation information, so that (rpx, rpy) is calculated as follows.

rpx=twinx+lpx=1700+320=2020

rpy=twiny+lpy=800+256=1056

Hence, as shown in FIG. 12, the cursor position of the cursor 8 on the screen 6 of the operation target device 1 is (2020, 1056).

Next, the second controller 11 of the operation target device 1 places the window 7C which is the operation target window, at the frontmost side (step S7). Further, the second controller 11 determines whether or not the cursor 8 on the screen 6 of the operation target device 1 is out of the screen 6 by using equation 3 and equation 4 (step S8). When (rpx, rpy)=(2020, 1056) and (dispw, disph)=(1920, 1080) are substituted in equation 3 and equation 4, 0≦2020<1920 (equation 3) and 0≦105 <1080 (equation 4) hold, and equation 3 is not satisfied. Hence, it is determined that the cursor 8 is out of the screen 6. Next, it is determined in step S8 that the cursor 8 is out of the screen 6, and then the second controller 11 calculates a position (ntwinx, tnwiny) at an upper right end of the operation target window 7C after movement by using equation 5 and equation 6 (step S9).

In this regard, (twinx, twiny)=(1700, 800), (rpx, rpy)=(2020, 1056), and (centerx, centery)=(1920/2=960, 1080/2=540) hold, and therefore in view of equation 5 and equation 6, the position (ntwinx, ntwiny) at the upper right end of the operation target window 7C after the movement is as follows.

ntwinx=twinx−(rpx−centerx)=1700−(2020−960)=648

ntwiny=twinx−(rpx−centerx)=800−(1056−540)=284

Next, the second controller 11 moves the window 7C such that the position at the upper right end of the operation target window 7C is (640, 284). Further, the second controller 11 moves the cursor position of the cursor 8 to a position (960, 540) at the center of the screen 6 (step S10). FIG. 13 shows a view showing the screen 6 after the window 7C and the cursor 8 are moved. According to the above processing, while a positional relationship between the operation target window 7C and the cursor 8 is maintained, the positions of the operation target window 7C and the cursor 8 are changed such that the cursor 8 comes in the screen 6.

Next, the second controller 11 changes the cursor position of the operation information to the same (960, 540) as the cursor position of the cursor 8 while keeping the operation type of the operation information as “WM_LBUTTONDOWN” (step S11). Further, the second controller 11 executes processing “WM_LBUTTONDOWN” with respect to the operation target window 7C based on the changed operation information (step S12).

In this regard, although, as described above, the operation target window and the cursor 8 are moved such that the cursor 8 of the operation target device 1 comes to the center of the screen 6, the cursor 8 does not necessarily need to come to the center of the screen 6, yet needs to come in the screen 6.

Meanwhile, when it is determined in step S8 that the cursor 8 of the operation target device 1 is not out of the screen 6 (i.e., the cursor 8 is in the screen 6), the flow moves to step S12. In this step, the second controller 11 executes processing “WM_LBUTTONDOWN” with respect to the operation target window 7C based on the operation information without changing the positions of the window 7C and the cursor 8.

<Effect>

The remote operating system according to the embodiment of the present invention is the remote operating system which includes the operation target device 1 and the remote operating device 2 connected via the network 3, and in which the remote operating device 2 includes the first communicator 22 which communicates with the operation target device 1 via the network 3, the operation recognizer 23 which recognizes an operation with respect to the remote operating device 2, the display signal interface 24 which outputs a display signal, and the first controller 21, the operation target device 1 includes the second communicator 12 which communicates with the remote operating device 2 via the network 3, and the second controller 11, the first controller 21 obtains a display window information list related to information of windows opened on the operation target device 1 via the first communicator 22, the first controller 21 causes the display signal interface 24 to output the display signal for displaying a window list based on the display window information list, the first controller 21 notifies the operation target device 1 of which window has been selected via the first communicator 22 when the operation recognizer 23 recognizes an operation of selecting one of windows in the window list, the first controller 21 causes the display signal interface 24 to output the display signal for displaying a remote operating window 10 corresponding to the selected window, the first controller 21 transmits operation information including an operation with respect to the remote operating window 10 recognized by the operation recognizer 23, to the operation target device 1 via the first communicator 22, the second communicator 12 receives which window has been selected from the window list, from the remote operating device 2, the second communicator 12 receives the operation information from the remote operating device 2, the second controller 11 calculates a cursor position on the operation target device 1 based on the operation information, and, when the cursor position is out of a movable area of the cursor 8, the second controller 11 changes a position of the selected window and the cursor position such that the cursor position comes in the movable area of the cursor 8 while maintaining a relative positional relationship between the position of the selected window and the cursor position, and then executes processing with respect to the selected window based on the operation information.

Consequently, the remote operating device 2 displays the selected window of a plurality of windows on the remote operating window 10, so that the user can operate only the selected window. Consequently, it is possible to prevent the user from operating another window.

Further, when a portion of an operation target window which needs to be operated is out of the screen 6 of the operation target device 1, a position of the window which needs to be operated is moved to the inside of the screen 6 in which the window can be operated by the cursor 8, and a cursor position is also simultaneously moved while maintaining a positional relationship with the window. Consequently, the user who operates the remote operating device 2 does not need to perform an operation of changing the position of the operation target window, so that it is possible to prevent the user from performing an erroneous operation. Further, even when a window of a larger size than the screen 6 is operated, it is possible to easily perform the operation.

Furthermore, in the remote operating system according to the embodiment of the present invention, the second controller 11 places the selected window at the frontmost side.

Consequently, even when an operation target window hides behind other windows on the operation target device 1, the operation target window is automatically placed at the frontmost side. Consequently, the user who operates the remote operating device 2 does not need to perform an operation of placing the operation target window at a front side, so that it is possible to prevent the user from performing an erroneous operation.

Further, an information processing method according to the embodiment of the present invention is an information processing method of a remote operating system including an operation target device 1 and a remote operating device 2 connected via a network 3, and includes: (a) at the remote operating device 2, obtaining a display window information list related to information of a window opened on the operation target device 1; (b) at the remote operating device 2, outputting a display signal for displaying a window list based on the display window information list; (c) at the remote operating device 2, notifying the operation target device 1 of which window has been selected when one of windows in the window list is selected; (d) at the remote operating device 2, outputting the display signal for displaying a remote operating window 10 corresponding to the selected window; (e) at the remote operating device 2, transmitting operation information including an operation with respect to the remote operating window 10, to the operation target device 1; (f) at the operation target device 1, receiving which window has been selected from the window list, from the remote operating device 2; (g) at the operation target device 1, receiving the operation information from the remote operating device 2; (h) at the operation target device 1, calculating a cursor position on the operation target device (1) based on the operation information; (i) after (h) and at the operation target device 1, when the calculated cursor position is out of a movable area of the cursor 8, changing a position of the selected window and the cursor position such that the cursor position comes in the movable area of the cursor 8 while maintaining a relative positional relationship between the position of the selected window and the calculated cursor position; and (j) after (i) and at the operation target device 1, executing processing with respect to the selected window based on the operation information.

Consequently, the remote operating device 2 displays the selected window of a plurality of windows on the remote operating window 10, so that the user can operate only the selected window. Consequently, it is possible to prevent the user from operating another window.

Further, when a portion of an operation target window which needs to be operated is out of the screen 6 of the operation target device 1, a position of the window which needs to be operated is moved to the inside of the screen 6 in which the window can be operated by the cursor 8, and a cursor position is also simultaneously moved while maintaining a positional relationship with the window. Consequently, the user who operates the remote operating device 2 does not need to perform an operation of changing the position of the operation target window, so that it is possible to prevent the user from performing an erroneous operation. Further, even when a window of a larger size than the screen 6 is operated, it is possible to easily perform the operation.

Furthermore, the information processing method according to the embodiment of the present invention further includes, (k) at the operation target device 1, placing the selected window at the frontmost side.

Consequently, even when an operation target window hides behind other windows on the operation target device 1, the operation target window is automatically placed at the frontmost side. Consequently, the user who operates the remote operating device 2 does not need to perform an operation of placing the operation target window at a front side, so that it is possible to prevent the user from performing an erroneous operation.

Although the present invention has been described in detail, the above description is exemplary in all aspects and the present invention is not limited thereto. It should be understood that an infinite number of modified examples which have not been exemplified are assumed without departing from the scope of the present invention.

### REFERENCE SIGNS LIST

1: operation target device

2: remote operating device

3: network

11: second controller

12: second communicator

13: operation recognizer

14: display signal interface

15: display

16: operation interface

21: first controller

22: first communicator

23: operation recognizer

24: display signal interface

25: display

26: operation interface

1a, 2a: processor

1b, 2b: communication device

1c, 2c: storage device

1d, 2d: input/output interface

1e, 2e: display

1f, 2f: keyboard

1g, 2g: mouse

6, 27: screen

8, 9: cursor

10: remote operating window

7A, 7B, 7C, 7D: window

1. A remote operating system comprising an operation target device and a remote operating device connected via a network wherein
said remote operating device includes:
a first communicator which communicates with said operation target device via said network;
an operation recognizer which recognizes an operation with respect to said remote operating device;
a display signal interface which outputs a display signal; and
a first controller, said operation target device includes:
a second communicator which communicates with said remote operating device via said network; and
a second controller,
said first controller obtains a display window information list related to information of a window opened on said operation target device via said first communicator,
said first controller causes said display signal interface to output the display signal for displaying a window list based on said display window information list,
said first controller notifies said operation target device of which window has been selected via said first communicator when said operation recognizer recognizes an operation of selecting one of windows in said window list,
said first controller causes said display signal interface to output the display signal for displaying a remote operating window corresponding to said selected window,
said first controller transmits operation information including an operation with respect to said remote operating window recognized by said operation recognizer, to said operation target device via said first communicator,
said second communicator receives which window has been selected from said window list, from said remote operating device,
said second communicator receives said operation information from said remote operating device,
said second controller calculates a cursor position on said operation target device based on said operation information, and
when said calculated cursor position is out of a movable area of the cursor, said second controller changes a position of said selected window and said cursor position such that said cursor position comes in the movable area of the cursor while maintaining a relative positional relationship between the position of said selected window and said calculated cursor position, and then executes processing with respect to said selected window based on said operation information.

2. The remote operating system according to claim 1, wherein said second controller places said selected window at a frontmost side.

3. An information processing method of a remote operating system comprising an operation target device and a remote operating device connected via a network, the information processing method comprising:
(a) at said remote operating device, obtaining a display window information list related to information of a window opened on said operation target device;
(b) at said remote operating device, outputting a display signal for displaying a window list based on said display window information list;
(c) at said remote operating device, notifying said operation target device of which window has been selected when one of windows in said window list is selected;
(d) at said remote operating device, outputting the display signal for displaying a remote operating window corresponding to said selected window;
(e) at said remote operating device, transmitting operation information including an operation with respect to said remote operating window, to said operation target device;
(f) at said operation target device receiving which window has been selected from said window list, from said remote operating device;
(g) at said operation target device, receiving said operation information from said remote operating device;
(h) at said operation target device, calculating a cursor position on said operation target device based on said operation information;
(i) after said (h) and at said operation target device, when said calculated cursor position is out of a movable area of the cursor, changing a position of said selected window and said cursor position such that said cursor position comes in the movable area of the cursor while maintaining a relative positional relationship between the position of said selected window and said calculated cursor position; and
(j) after said (i) and at said operation target device, executing processing with respect to said selected window based on said operation information.

4. The information processing method according to claim 3, further comprising (k) at said operation target device, placing said selected window at a frontmost side.
